(19) United States
(12) Patent Application Publication
(10) Pub. No.: US 2024/0022624 A1
(43) Pub. Date: Jan. 18, 2024

(54) ERROR RESPONSE DETECTION IN HTTP-BASED COMMUNICATIONS

(71) Applicant: VMWARE, INC, Palo Alto, CA (US)

(72) Inventors: Deyan Popov, Sofia (BG); Bisser Peshev, Sliven (BG); Grigor Harbaliev, Sofia (BG)

(21) Appl. No.: 17/866,474

(22) Filed: Jul. 16, 2022

(51) Int. Cl. H04L 67/02; H04L 12/66

(52) U.S. Cl. CPC H04L 67/02; H04L 12/66

(57) ABSTRACT

In an example, a gateway device includes a gateway application to receive a hypertext transfer protocol (HTTP) request from a client device and transmit the HTTP request to a server. Further, the gateway application may receive an HTTP response from the server responsive to the HTTP request and determine whether a size of a response body of the HTTP response is less than a threshold. In response to determining the size of the response body is less than the threshold, the gateway application may determine whether the response body includes a predefined sequence. Further, in response to determining that the response body includes the predefined sequence, the gateway application may parse the response body to determine whether the HTTP response is an error response of interest. In response to determining that the HTTP response is the error response of interest, the gateway application may manage the HTTP response.

### TECHNICAL FIELD

The present disclosure relates to computing environments, and more particularly to methods, techniques, and systems for detecting error responses in hypertext transfer protocol (HTTP)-based communications.

### BACKGROUND

A web application is a computer software application that is hosted in a web browser-controlled environment or coded in a web browser-supported language (such as JavaScript, combined with a browser-rendered markup language like Hyper Text Markup Language (HTML)) and reliant on a common web browser to render the application executable. The Hypertext Transfer Protocol (HTTP) is a networking protocol that functions as a request-response protocol in the client-server computing model. In the HTTP, a web browser, for example, acts as a client (referred to as an HTTP client running on a client device), while a web application running on a computer hosting a web site functions as a server (referred to as a web application server running on a server).

The HTTP client submits an HTTP request to the web application server. The web application server, which stores content, or provides resources, such as HTML files, or performs other functions on behalf of the HTTP client, returns an HTTP response to the HTTP client. The HTTP response may include completion status information about the HTTP request and also include any content requested by the HTTP client in the response body. Such client-server computing models may utilize a gateway device to process the HTTP requests from the client device, provide a unified authentication for the requested service, and also routes the response received from the server to the client device. In such client-server computing models, the gateway devices may have to intercept certain error responses received from the server in order to modify and resend the HTTP requests.

### BRIEF DESCRIPTION OF THE DRAWINGS

FIG. 1 is a block diagram of an example system, depicting a gateway device to determine an error response in hypertext transfer protocol (HTTP)-based communications;

FIG. 2 is a flow diagram illustrating an example method for determining error responses in HTTP-based communications;

FIG. 3A is an example HTTP response including a header with content-length information;

FIG. 3B is another example HTTP response including a header with content-length information;

FIG. 3C is an example HTTP response including a header without content-length information;

FIG. 3D is another example HTTP response including a header without content-length information; and

FIG. 4 is a block diagram of an example gateway device including non-transitory machine-readable storage medium storing instructions to determine an error response in HTTP-based communications.

The drawings described herein are for illustration purposes and are not intended to limit the scope of the present subject matter in any way.

### DETAILED DESCRIPTION

Examples described herein may provide an enhanced computer-based and/or network-based method, technique, and system to determine error responses in hypertext transfer protocol (HTTP)-based communications. The paragraphs to provide an overview of the HTTP-based communications, existing methods for processing HTTP requests/responses, and drawbacks associated with the existing methods in detecting the error responses.

An HTTP protocol is a request-reply protocol where a client device sends a request to a server and the client device waits for a reply or response from the server. A gateway device coordinates and orchestrates requests and responses between client devices and the servers. For example, when the gateway device receives an HTTP request from the client device, looks up for a service that serves the HTTP request, and delivers the HTTP request to the server associated with the service. Further, the gateway device may receive an HTTP response responsive to the HTTP request from the server and returns the HTTP response to the client device. The HTTP response may include an HTTP status code, a set of additional HTTP headers that are specified by parameter mappings, a payload, and the like. Besides this routing task, the gateway device can also perform authentication, input validation, load balancing, centralized middleware functionality, and the like. An example gateway device may be vCenter API Gateway offered by VMwaree.

In some examples, the gateway device may provide a unified authentication over a set of services and may retry an HTTP request if its cached authentication token for a given service has expired. In such examples, the gateway device identifies the error response based on an HTTP status code or HTTP headers in the HTTP response. However, in some examples, the error responses cannot be distinguished based on the HTTP status codes or HTTP headers. For example, the HTTP response may include an HTTP status code “200” for all kinds of errors. The HTTP status code “200” (OK) indicates that the request has succeeded. In such a scenario, the gateway device may have to analyze a response body of the HTTP response to distinguish the error responses. Such scenarios may occur when the gateway device has to interoperate with legacy systems and/or protocols which cannot be changed either because of not having control over them (e.g., old releases deployed on-premises) or the change may break existing client communications. In such cases, the HTTP response may have to include an HTTP status code 401 (e.g., indicating that the client request has not been processed because it lacks valid authentication credentials for the requested resource) instead of “200”.

Further, interpreting text-based protocols (e.g., an extensible markup language (XML) parsing, a JavaScript object notation (JSON) parsing, or the like) to distinguish the error responses may be more complex and resource-intensive compared to binary protocols since the HTTP response bodies may be significantly large (e.g., several MB) for non-error responses. Thus, it is desirable for the gateway device to avoid loading and parsing the whole HTTP response body in memory (e.g., XML document object model (DOM) parsing the body) to distinguish the error responses.

Examples described herein may provide a gateway device to detect an HTTP response as an error response without parsing the complete response body of the HTTP response. In an example, the gateway device includes a gateway application to receive an HTTP request from a client device. Further, the gateway application may transmit the HTTP request to a server and, responsive to the HTTP request, receive an HTTP response from the server. Furthermore, the gateway application may determine whether a size of a response body of the HTTP response is less than a threshold. In response to determining the size of the response body is less than the threshold, the gateway application may determine whether the response body includes a predefined sequence. Further, in response to determining that the response body includes the predefined sequence, the gateway application may parse the response body to determine that the HTTP response is an error response of interest and manage the HTTP response based on a type of the error response.

In the following description, for purposes of explanation, numerous specific details are set forth to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

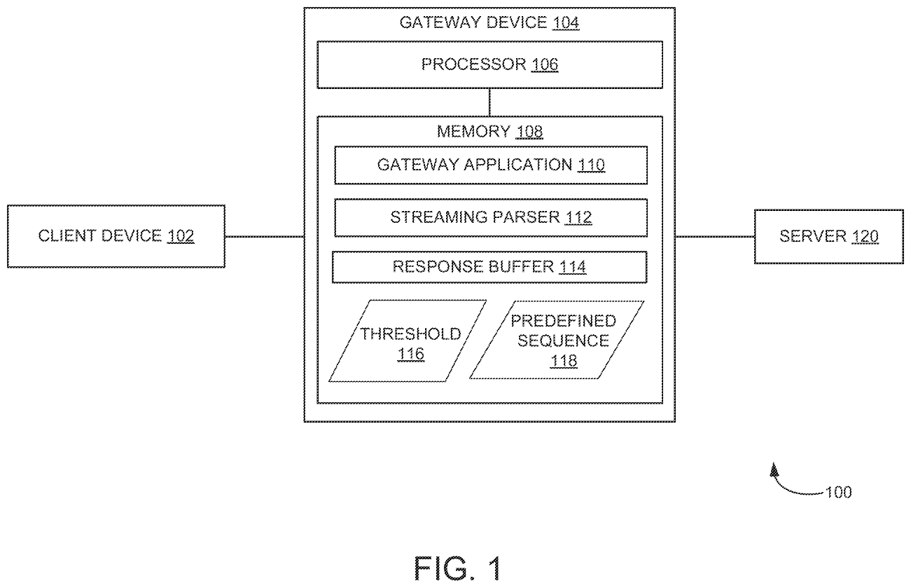

FIG. 1 is a block diagram of an example system 100, depicting a gateway device 104 to determine an error response in hypertext transfer protocol (HTTP)-based communications. An HTTP may refer to a formally defined set of rules for communication between a client device 102 (e.g., a network resource requesting data or services) and a server 120 (e.g., a resource that receives and responds to the request) via a network. The HTTP is an agreed-upon set of rules, conventions, and data structures that determine how resources exchange data. For example, the HTTP may be used with a web browser client (e.g., Chrome, Safari, Edge, or the like) and a web server running on a computer system located somewhere on the Internet. In other examples, the HTTP supports many other web applications and services.

An example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a virtual private network (VPN), intranet or other suitable network system and includes equipment for receiving and transmitting signals.

As shown in FIG. 1, system 100 includes client device 102 and server 120 communicatively connected to client device 102 via gateway device 104. Even though system 100 is depicted as including a single client device 102 and server 120, system 100 can include multiple client devices and servers interactively connected via gateway device 104. Example client device 102 may be a networked requester of services from server 120. For example, a web browser (i.e., running in client device 102) may request to download a web page from a web server or to upload and send an email message via a mail server. Server 120 may be a networked provider of resources or services to client device 102. For example, a web server may deliver web page content along with other services to web browsers that request such services.

Gateway device 104 may be a computer or computer program that acts as an intermediary between client device 102 requesting a resource and server 120 providing the requested resource. Gateway device 104 may route traffic from client device 102 to an outside network that is serving up web pages. Further, gateway device 104 may include a processor 106 and a memory 108 coupled to processor 106. Processor 106 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 106 may, for example, include single or multiple cores on a chip, multiple cores across multiple chips, multiple cores across multiple devices, or suitable combinations thereof. Processor 106 may be functional to fetch, decode, and execute instructions as described herein.

Further, memory 108 may include a gateway application 110, a streaming parser 112, and a response buffer 114 communicatively connected to each other. In an example, gateway application 110 may be an application programming interface (API) Gateway. The APIs may be specifications intended to be used as interfaces by the components (e.g., client device 102 and server 120) to communicate with each other. For example, the APIs can include specifications for routines, data structures, object classes, and variables. Further, the API Gateway may support different text-based protocols (e.g., a simple object access protocol (SOAP), an extensible markup language (XML)-remote procedure call (RPC), a JSON-RPC, flavors of REST, and the like).

During operation, gateway application 110 may receive an HTTP request from a client device. For example, the HTTP request is made by client device 102, to a named host, which is located on server 120. The aim of the HTTP request is to access a resource on server 120. In the context of HTTP, a request is a message sent from client device 102 to server 120 (e.g., a web server) that specifies an action to be performed on the resource. To make the HTTP request, client device 102 may use components of a uniform resource locator (URL), which includes the information needed to access the resource. Further, gateway application 110 may transmit the HTTP request to server 120. In some examples, the gateway application 110 may transmit the HTTP request to server 120 based on the URL included in the HTTP request. Furthermore, gateway application 110 may receive an HTTP response from server 120 responsive to the HTTP request. For example, the HTTP response is made by server 120 to client device 102. The aim of the response may be to provide client device 102 with the resource client device 102 requested, inform client device 102 that the action requested in the HTTP request has been carried out, or else to inform client device 102 that an error occurred in processing the HTTP request.

In an example, the HTTP response may include a status line including HTTP status code to identify an error response, response header fields or a series of HTTP headers, a response body, and/or the like. The response body refers to data bytes transmitted in the HTTP response following the headers, if any. For a response to a successful request, the response body may include either information about the status of the action which is requested by client device 102 or the resource which is requested by client device 102. For the response to an unsuccessful request, the response body may provide further information related to some action client device 102 has to take to complete the request successfully or related to the reason for the error.

Further, gateway application 110 may determine whether a size of the response body of the HTTP response is less than a threshold 116. For example, the threshold 116 may be predefined for error responses (e.g., a few kilo bytes (KB)). If the response body is greater than the threshold, then the HTTP response is considered as not an error response.

In an example, gateway application 110 may receive the HTTP response including content-length information in a header of the HTTP response and determine whether the size of the response body is less than the threshold using the content-length information included in the header. For example, the content-length information may include a value that describes the size of the response body.

In another example, gateway application 110 may initiate loading chunks of the response body in response buffer 114 and determine whether the size of the response body is less than threshold 116 based on determining whether the size of response buffer 114 exceeds threshold 116.

In response to determining the size of the response body is less than threshold 116, gateway application 110 may determine whether the response body includes a predefined sequence 118. In an example, predefined sequence 118 may depend on a type of text-based protocol supported by gateway device 104, a type of a service provided by server 120, or a combination thereof. In response to determining that the response body includes predefined sequence 118, gateway application 110 may parse the response body to determine whether the HTTP response is an error response of interest. For example, when predefined sequence 118 is missing, gateway application 110 may conclude that the HTTP response is not a particular type of error response and hence, no further processing of the HTTP response is needed. However, when predefined sequence 118 is present in the response body, the HTTP response may or may not be an error response. In this example, the gateway application 110 may parse the HTTP response to determine whether the HTTP response is the error response of interest.

In an example, gateway application 110 may parse the response body to validate/verify the HTTP response as the error response of interest. The error response of interest may refer to an error response which needs special processing by gateway application 110. In other examples, there can be multiple error responses in which gateway application 110 may be interested. In this example, determining that the HTTP response is the error response of interest includes validating that the HTTP response is an error response in which gateway application 110 is interested. For example, gateway application 110 may employ streaming parser 112 to parse the response body as the response body is streaming through streaming parser 112 and terminate parsing of the response body by streaming parser 112 upon determining that the HTTP response is the error response of interest. Thus, gateway device 104 utilizes streaming parser 112 to avoid loading and parsing the whole HTTP response body in memory 108. In response to determining that the HTTP response is the error response of interest, gateway application 110 may manage the HTTP response based on a type of the error response.

In an example, gateway application 110 may determine the type of the error response. Based on the type of the error response, gateway application 110 may transmit the error response to client device 102 or handle the error response via retransmitting the HTTP request with modified information to server 120. For example, when the type of the error response indicates an expiration of a security token, gateway application 110 may modify the HTTP request to include a new security token to establish a secure session between client device 102 and server 120 and send the modified HTTP request to server 120.

In response to determining that the size of the response body is not less than threshold 116, in response to determining the response body does not include predefined sequence 118, or in response to determining that the HTTP response is not the error response of interest, gateway application 110 may transmit the HTTP response to client device 102. Even though gateway application 110 described herein may determine whether an HTTP response is an error response of interest, gateway application 110 can also intercept any kind of responses that are of interest and perform processing on such responses.

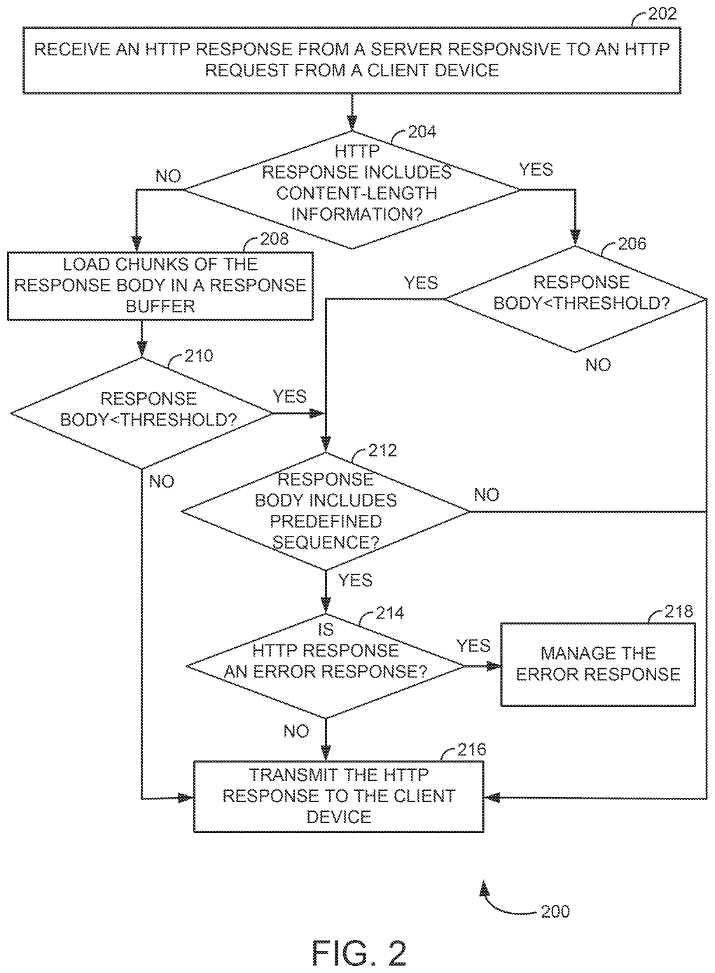

FIG. 2 is a flow diagram illustrating an example method 200 for determining error responses in HTTP-based communications. Example method 200 depicted in FIG. 2 represents generalized illustrations, and that other processes may be added, or existing processes may be removed, modified, or rearranged without departing from the scope and spirit of the present application. In addition, method 200 may represent instructions stored on a computer-readable storage medium that, when executed, may cause a processor to respond, to perform actions, to change states, and/or to make decisions. Alternatively, method 200 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but rather the flow chart illustrates functional information to design/fabricate circuits, generate computer-readable instructions, or use a combination of hardware and computer-readable instructions to perform the illustrated processes.

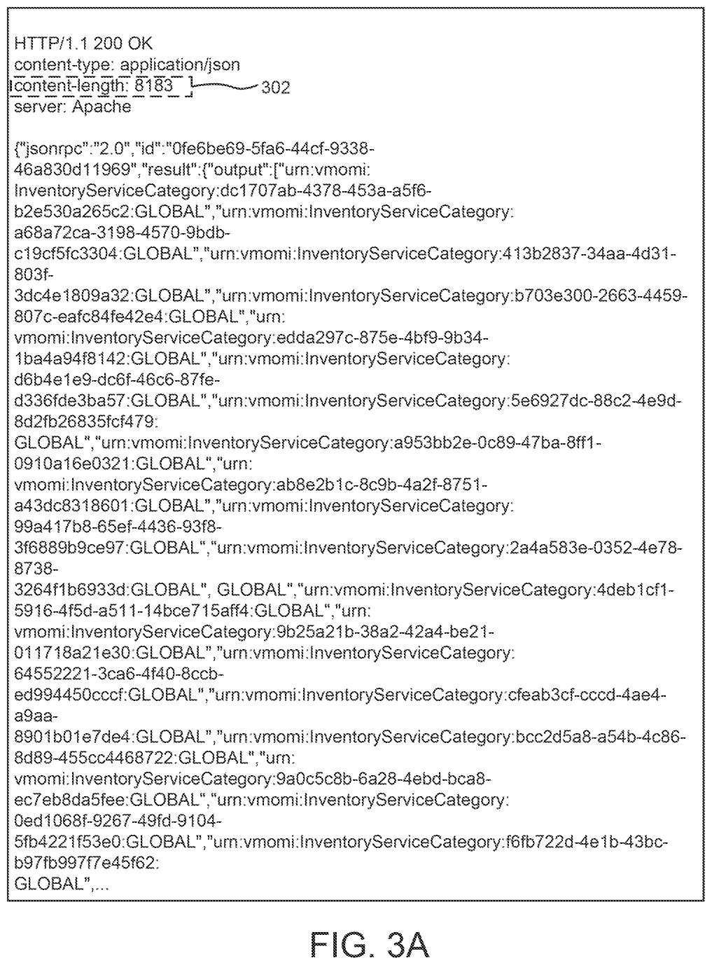

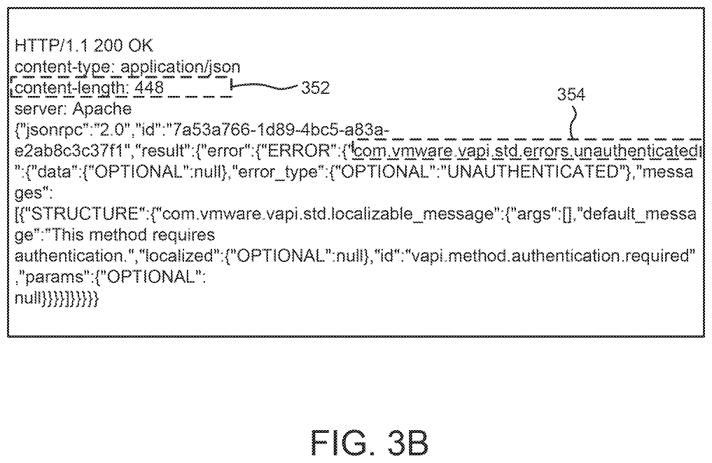

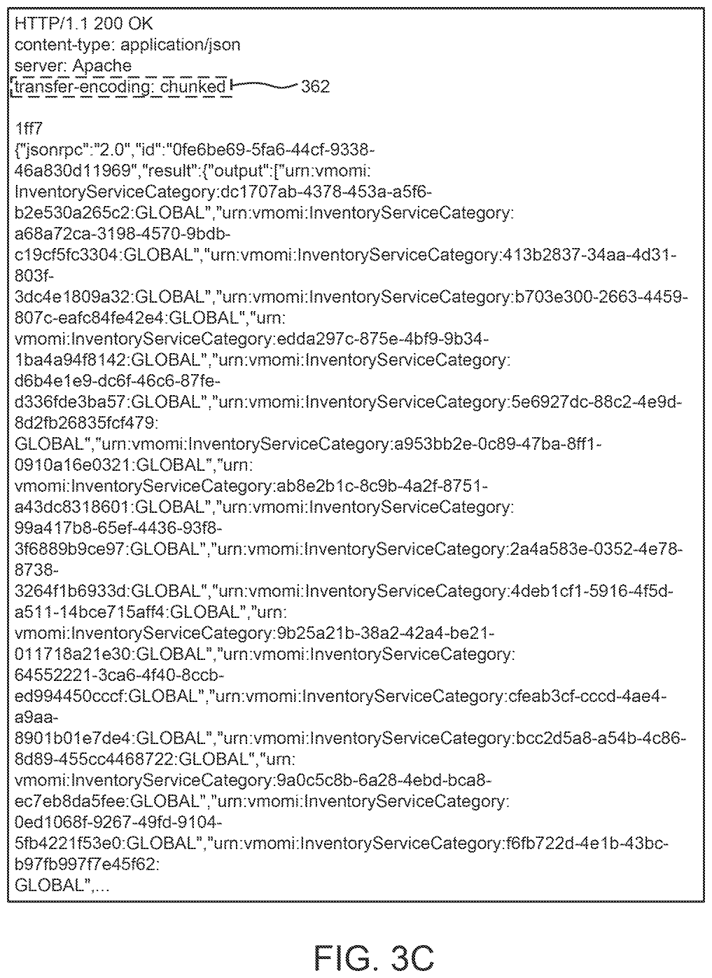

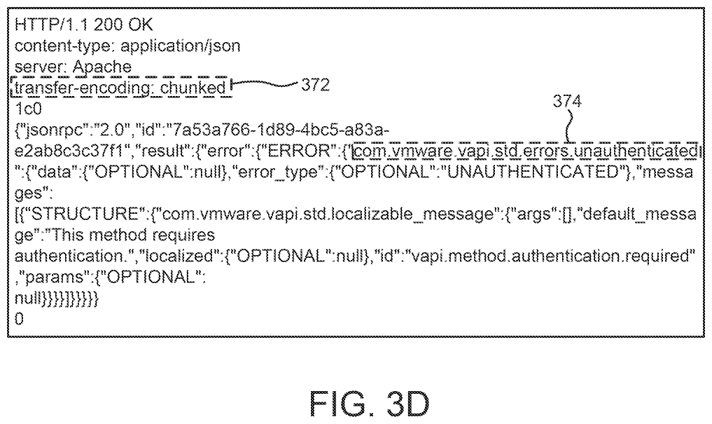

At 202, an HTTP response may be received from a server responsive to an HTTP request from a client device. For example, the HTTP request and the HTTP response may be referred as HTTP messages. The HTTP message includes data exchanged between the client device and the server. A request sent by the client device to trigger an action on the server may be referred to as the HTTP request and a response or an answer from the server may be referred to as the HTTP response. Further, the HTTP response may include a header (e.g., to include content-length information, a content type, details of the server, or the like) and a response body including the content. Examples of HTTP responses are depicted in FIGS. 3A, 3B, 3C, and 3D. FIG. 3A is an example HTTP response including a header with content-length information (e.g., 302). FIG. 3B is another example HTTP response including a header with content-length information (e.g., 352). FIG. 3C is an example HTTP response including a header without content-length information. FIG. 3D is another example HTTP response including a header without content-length information.

Referring back to FIG. 2, at 204, a check may be made to determine whether the HTTP response includes the content-length information in the header. For example, the HTTP responses in FIGS. 3A and 3B include content-length information (e.g., 302 in FIG. 3A and 352 in FIG. 3B). However, the HTTP responses in FIGS. 3C and 3D do not include content-length information as the HTTP responses are transferred in chunks (e.g., 362 in FIG. 3C and 372 in FIG. 3D).

When the HTTP response includes the content-length information (e.g., as shown as 302 in FIG. 3A and 352 in FIG. 3B), a check may be made to determine whether a size of a response body of the HTTP response is less than a threshold using the content-length information, at 206. For example, consider the threshold is defined as “500” bytes for error responses.

In the example HTTP response of FIG. 3A, when the content-length “8183” bytes (e.g., as shown as 302) is compared with the threshold “500” bytes, the content-length is not less than the threshold. In the example HTTP response of FIG. 3B, when the content-length “448” bytes (e.g., as shown as 352) is compared with the threshold “500” bytes, the content-length is less than the threshold.

Referring back to FIG. 2, at 208, when the HTTP response does not include the content-length information, chunks of the response body may be loaded in a response buffer. In an example, the chunks of the response body of the response may be loaded in the response buffer until a completion of loading of the response body or until the response buffer exceeds the threshold, whichever occurs earlier. Further at 210, a check may be made to determine whether the size of the response body is less than the threshold using the response buffer. In an example, when the completion of loading of the response body in the response buffer occurs earlier, the size of the response body is determined as less than the threshold. In another example, when the response buffer exceeding the threshold occurs earlier, the size of the response body is determined as not less than the threshold.

In the example HTTP responses of FIGS. 3C and 3D, where the content-length information is not present, the chunks of the response body of the HTTP responses may be loaded in the response buffer until the response body ends or until the size of the response buffer exceeds the threshold (e.g., whichever occurs first). If the response buffer exceeded the threshold, the response body is considered as greater than the threshold. In the example HTTP responses in FIGS. 3C and 3D, based on the response buffer and the threshold, the size of the response body in FIG. 3C is determined as not less than the threshold and the size of the response body in FIG. 3D is determined as less than the threshold.

Referring back to FIG. 2, in response to determining the size of the response body is less than the threshold at 206 or 210, a check may be made to determine whether the response body includes a predefined sequence, at 212. The predefined sequence may depend on a type of text-based protocol supported by the gateway device, a type of a service provided by the server, or a combination thereof. For example, consider the predefined sequence as UTF-8 encoding of string “com.vmware.vapi.std.errors.unauthenticated”. In the example HTTP responses shown in FIGS. 3B and 3D, the response body includes the predefined sequence as shown in 354 (e.g., of FIG. 3B) and 374 (e.g., of FIG. 3D).

Referring back to FIG. 2, in response to determining that the response body includes the predefined sequence, at 214, the response body may be parsed to determine whether the HTTP response is an error response of interest (e.g., an error response which needs special processing by the gateway device). In an example, in response to determining that the response body includes the predefined sequence, the response body may be parsed using a streaming parser to determine whether the HTTP response is the error response of interest. In this example, the streaming parser may stop parsing upon determining that the response body is the error response of interest. For example, a JSON parser, an XML parser, or the like may be used for parsing the response body.

When the HTTP response is not the error response in which a gateway application is interested, the HTTP response may be transmitted to the client device, at 216. Upon determining that the HTTP response is the error response of interest (i.e., when the HTTP response is determined as the error response in which the gateway application is interested), the error response may be managed, at 218. In this example, a type of the error response may be determined. Based on the type of the error response, the HTTP request with modified information (e.g., add a new authentication token for the requested service) may be transmitted to the server. In another example, based on the type of the error response, the error response may be transmitted to the client device (i.e., when the gateway application cannot, or chooses not to, handle the error response).

In response to determining that the size of the response body is not less than the threshold (e.g., at 206 and 210), in response to determining the response body does not include the predefined sequence (e.g., at 212), or in response to determining that the HTTP response is not the error response of interest (e.g., at 214), the HTTP response may be determined as not an error response or as an error response in which a gateway application is not interested, and the HTTP response may be transmitted to the client device, at 216. For example, in the example HTTP responses of FIGS. 3A and 3C, the size of the response body is not less than the threshold. Therefore, the HTTP responses of FIGS. 3A and 3C are considered as normal responses and sent to the client device.

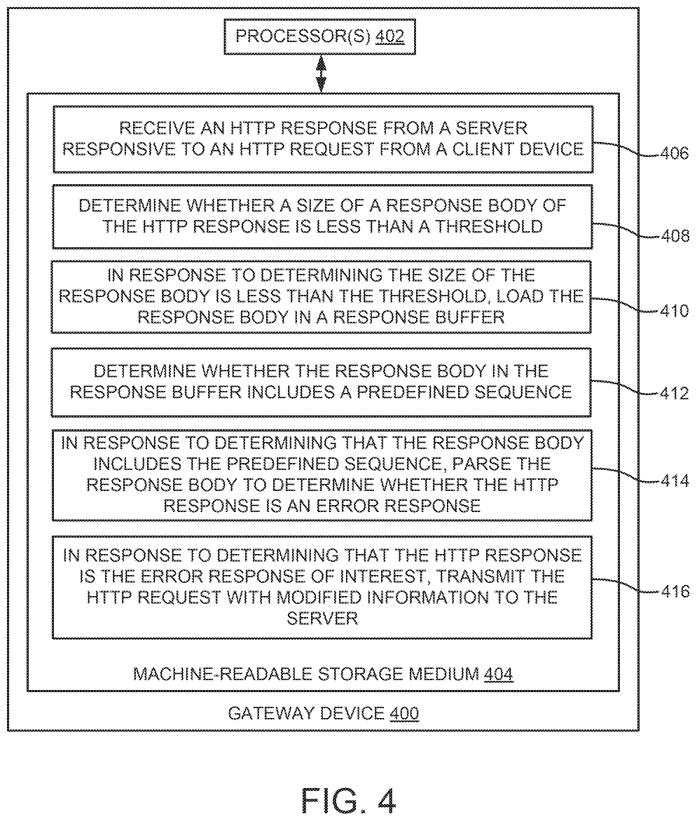

FIG. 4 is a block diagram of an example gateway device 400 including non-transitory machine-readable storage medium 404 storing instructions to determine an error response in HTTP-based communications. Gateway device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to gateway device 400.

Machine-readable storage medium 404 may store instructions 406, 408, 410, 412, 414, and 416. Instructions 406 may be executed by processor 402 to receive an HTTP response from a server responsive to an HTTP request from a client device.

Instructions 408 may be executed by processor 402 to determine whether a size of a response body of the HTTP response is less than a threshold. In an example, instructions 408 to determine whether the size of the response body of the HTTP response is less than the threshold include instructions to:
determine whether the HTTP response includes content-length information in a header of the HTTP response, and
when the HTTP response includes the content-length information, determine whether the size of the response body is less than the threshold using the content-length information.

When the HTTP response does not include the content-length information, instructions 408 to determine whether the size of the response body of the HTTP response is less than the threshold include instructions to:
load chunks of the response body in the response buffer, and
determine whether the size of the response body is less than the threshold using the response buffer.

In response to determining the size of the response body is less than the threshold, instructions 410 may be executed by processor 402 to load the response body in a response buffer. Instructions 412 may be executed by processor 402 to determine whether the response body in the response buffer includes a predefined sequence.

In response to determining that the response body includes the predefined sequence, instructions 414 may be executed by processor 402 to parse the response body to determine whether the HTTP response is an error response of interest. In an example, the response body may be parsed to determine whether the HTTP response is the error response of interest using a streaming parser.

In response to determining that the HTTP response is the error response of interest, instructions 416 may be executed by processor 402 to transmit the HTTP request with modified information to the server. In this example, the HTTP request may be modified or tweaked based on a type of the error response. For example, when the error response is received because of an expiration of a security token (e.g., a session identifier), i.e., unauthenticated error, a new or fresh session identifier may be included in the HTTP request and the HTTP request with new session identifier may be transmitted. For example, authentication schemes may provide a method for making authenticated HTTP requests using the security token. The security token refers to the session identifier used to denote an access grant with specific scope, duration, cryptographic properties, and other attributes. The security token may be used to establish a session at a certain point in time and torn down at a later point in time (i.e., after the duration). The security token can be issued by the server, self-issued by the client, or issued by a third-party.

In response to determining that the size of the response body is not less than the threshold, in response to determining the response body does not include the predefined sequence, or in response to determining that the HTTP response is not the error response of interest, machine-readable storage medium 404 may store instructions to transmit the HTTP response to the client device.

Some or all of the system components and/or data structures may also be stored as contents (e.g., as executable or other machine-readable software instructions or structured data) on a non-transitory machine-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the machine-readable medium and/or one or more host computing systems or devices to execute or otherwise use or provide the contents to perform at least some of the described techniques.

Thus, the gateway device described herein may avoid loading and parsing the whole HTTP response body in memory (e.g., XML DOM parsing the body) by streaming the response bytes from upstream services through the gateway device to the client device. In other words, the gateway device reads the HTTP response from an upstream service in chunks and send each chunk back to the client device before reading the next chunk, so that the memory overhead can be minimized.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

1. A gateway device comprising:
a processor; and
a memory coupled to the processor, wherein the memory comprises a gateway application to:
receive a hypertext transfer protocol (HTTP) request from a client device;
transmit the HTTP request to a server;
receive an HTTP response from the server responsive to the HTTP request;
determine whether a size of a response body of the HTTP response is less than a threshold;
in response to determining the size of the response body is less than the threshold, determine whether the response body includes a predefined sequence;
in response to determining that the response body includes the predefined sequence, parse the response body to determine whether the HTTP response is an error response of interest; and
in response to determining that the HTTP response is the error response of interest, manage the HTTP response.

2. The gateway device of claim 1, wherein the gateway application is to:
employ a streaming parser to parse the response body as the response body is streaming through the streaming parser; and
terminate parsing of the response body by the streaming parser upon determining that the HTTP response is the error response of interest.

3. The gateway device of claim 1, wherein the gateway application is to:
in response to determining that the size of the response body is not less than the threshold, in response to determining that the response body does not include the predefined sequence, or in response to determining that the HTTP response is not the error response of interest, transmit the HTTP response to the client device.

4. The gateway device of claim 1, wherein the gateway application is to:
determine a type of the error response; and
based on the type of the error response:
transmit the error response to the client device; or
handle the error response via retransmitting the HTTP request with modified information to the server.

5. The gateway device of claim 1, wherein the gateway application is to:
receive the HTTP response including content-length information in a header of the HTTP response; and
determine whether the size of the response body is less than the threshold using the content-length information included in the header.

6. The gateway device of claim 1, wherein the gateway application is to:
initiate loading chunks of the response body in a response buffer; and
determine whether the size of the response body is less than the threshold based on determining whether a size of the response buffer exceeds the threshold.

7. The gateway device of claim 6, wherein the gateway application is to:
when a completion of loading of the response body in the response buffer occurs earlier, determine that the size of the response body is less than the threshold; and
when the response buffer exceeds the threshold occurs earlier, determine that the size of the response body is not less than the threshold.

8. The gateway device of claim 1, wherein the predefined sequence depends on a type of text-based protocol supported by the gateway device, a type of a service provided by the server, or a combination thereof.

9. A method comprising:
receiving a hypertext transfer protocol (HTTP) response from a server responsive to an HTTP request from a client device;
determining whether the HTTP response includes content-length information in a header;
when the HTTP response includes the content-length information, determining whether a size of a response body of the HTTP response is less than a threshold using the content-length information;
when the HTTP response does not include the content-length information:
loading chunks of the response body in a response buffer; and
determining whether the size of the response body is less than the threshold using the response buffer;
in response to determining the size of the response body is less than the threshold, determining whether the response body includes a predefined sequence; and
in response to determining that the response body includes the predefined sequence, parsing the response body to determine whether the HTTP response is an error response of interest.

10. The method of claim 9, further comprising:
in response to determining that the HTTP response is the error response of interest, determining a type of the error response; and
based on the type of the error response:
transmitting the error response to the client device; or
handling the error response via retransmitting the HTTP request with modified information to the server.

11. The method of claim 9, further comprising
in response to determining that the size of the response body is not less than the threshold, in response to determining the response body does not include the predefined sequence, or in response to determining that the HTTP response is not the error response of interest, transmitting the HTTP response to the client device.

12. The method of claim 9, wherein parsing the response body to determine whether the HTTP response is the error response of interest comprises:
in response to determining that the response body includes the predefined sequence, parsing the response body using a streaming parser to determine whether the HTTP response is the error response of interest.

13. The method of claim 9, wherein loading chunks of the response body in the response buffer comprises:
loading chunks of the response body of the response in the response buffer until a completion of loading of the response body or until the response buffer exceeds the threshold, whichever occurs earlier.

14. The method of claim 13, wherein determining whether the size of the response body is less than the threshold using the response buffer comprises:
when the completion of loading of the response body in the response buffer occurs earlier, determining that the size of the response body is less than the threshold; and
when the response buffer exceeding the threshold occurs earlier, determining that the size of the response body is not less than the threshold.

15. The method of claim 9, wherein the predefined sequence depends on a type of text-based protocol supported by the gateway device, a type of a service provided by the server, or a combination thereof.

16. A non-transitory machine-readable storage medium comprising instructions that, when executed by a processor of a gateway device, cause the processor to:
receive a hypertext transfer protocol (HTTP) response from a server responsive to an HTTP request from a client device;
determine whether a size of a response body of the HTTP response is less than a threshold;
in response to determining the size of the response body is less than the threshold, load the response body in a response buffer;
determine whether the response body in the response buffer includes a predefined sequence;
in response to determining that the response body includes the predefined sequence, parse the response body to determine whether the HTTP response is an error response of interest; and
in response to determining that the HTTP response is the error response of interest, transmit the HTTP request with modified information to the server.

17. The non-transitory machine-readable storage medium of claim 16, wherein instructions to determine whether the size of the response body of the HTTP response is less than the threshold comprise instructions to:
determine whether the HTTP response includes content-length information in a header of the HTTP response; and
when the HTTP response includes the content-length information, determine whether the size of the response body is less than the threshold using the content-length information.

18. The non-transitory machine-readable storage medium of claim 17, further comprising instructions that, when executed by the processor, cause the processor to:
when the HTTP response does not include the content-length information:
load chunks of the response body in the response buffer; and
determine whether the size of the response body is less than the threshold using the response buffer.

19. The non-transitory machine-readable storage medium of claim 16, wherein instructions to parse the response body to determine whether the HTTP response is the error response of interest comprise instructions to:
parse the response body to determine the HTTP response as the error response of interest using a streaming parser.

20. The non-transitory machine-readable storage medium of claim 16, further comprising instructions that, when executed by the processor, cause the processor to:
in response to determining that the size of the response body is not less than the threshold, in response to determining that the response body does not include the predefined sequence, or in response to determining that the HTTP response is not the error response of interest, transmit the HTTP response to the client device.
